(19) United States
(12) Patent Application Publication
(10) Pub. No.: US 2015/0104761 A1
(43) Pub. Date: Apr. 16, 2015

(54) Adaptive Grammar Instruction For Run-On Sentences

(71) Applicant: Apollo Group, Inc., Phoenix, AZ (US)

(72) Inventors: Brendon Towle, Los Angeles, CA (US); Michael Wasson, Pittsburgh, PA (US); Linda Schmandt, Pittsburgh, PA (US)

(73) Assignee: APOLLO GROUP, INC., PHOENIX, AZ (US)

(21) Appl. No.: 14/053,517

(22) Filed: Oct. 14, 2013

(51) Int. Cl. G09B 19/04; G09B 7/00; G06F 17/27

(52) U.S. Cl. CPC G09B 19/04; G06F 17/274; G09B 7/00
USPC 434/169

(57) ABSTRACT

An automated grammar teaching system displays one or more sentences and allows a user to identify a location of a run-on sentence error within a sentence. The system further allows the user to correct the identified run-on sentence error. In an embodiment, if a user incorrectly identifies a particular portion of a sentence as a run-on sentence error, then the system displays remediation information to help the user understand the portion of the sentence that the user selected. In an embodiment, if a user provides an inaccurate correction to a run-on sentence error, the system displays remediation information to explain why the correction that the user input is inaccurate. Further, the automated grammar teaching system records, as historical data, a user's actions within the system. The system uses this historical data to identify what sentences, with what kinds of run-on sentence errors, the system should provide to the user.

### BENEFIT CLAIM AND CROSS-REFERENCE TO RELATED APPLICATIONS

This application is related to Provisional Appln. No. 61/______, filed Oct. 14, 2013, titled “Adaptive Grammar Instruction” (attorney docket number 60201-0358), the entire contents of which is hereby incorporated by reference as if fully set forth herein, under 35 U.S.C. §119(e). This application is also related to application Ser. No. 13/875,107, titled “Multi-Layered Cognitive Tutor”, filed May 1, 2013, and to application Ser. No. ______, titled “Adaptive Grammar Instruction”, filed Oct. 14, 2013 (Attorney Ref. No. 60201-0351), the entire contents of each of which is hereby incorporated by reference as if fully set forth herein.

### FIELD OF THE INVENTION

The present invention relates to teaching natural language rules of grammar, and, more specifically, to an adaptive grammar teaching system configured to train users on identifying the location of, and correcting, run-on sentence errors within natural language sentences.

### BACKGROUND

Natural languages are spoken languages (such as American English), which have grammar rules governing the composition of the natural language. When a person has not learned the proper rules of grammar for a natural language, the student encounters difficulty in communicating using the natural language. For example, it may be particularly difficult for a person that does not understand the grammatical rules of American English to write an error-free research paper or formal letter, which limits that person's ability to communicate effectively through writing.

Grammar checkers, e.g., Grammerly.com, Thelma Thistleblossom, and grammar checkers included with document editors such as Microsoft Word, identify certain types of grammatical errors in written documents. However, grammar error identification/correction is not the same as teaching grammar rules, even when the grammar checker indicates why each identified error is an error. Thus, grammar checkers generally do not teach the rules of grammar, nor do grammar checkers target particular problems that users have with grammatical rules. At times, the grammar checkers identify “errors” that are not grammatical errors at all, and rely on the knowledge of the user to ultimately determine whether an error exists. Thus, grammar checkers are generally ineffective at teaching a user the rules of grammar of a natural language.

Some English courses, e.g., in secondary and higher education, attempt to teach the rules of natural language grammar, largely using face-to-face teaching techniques, quizzes, and other activities. At times, automation is used in such traditional English courses. However, this automation generally consists of providing a student with multiple-choice questions and giving the student feedback on the student's selected answers. It can be difficult for an English teacher to identify and aid each student with the students' individual grammar misconceptions, especially since classes tend to be large and students tend to have a wide range of skill gaps with respect to mastery of English grammar rules. At least the above mentioned deficiencies can allow students to complete English courses without learning all of the natural language grammar rules that they need to produce error-free communications.

Therefore, it would be beneficial to provide an automated grammar teaching system that is configured to teach natural language grammar concepts targeted to the needs of students.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example network arrangement for an automated grammar teaching system that adaptively instructs a user regarding grammar rules governing run-on sentences.

FIG. 2 depicts a flowchart for receiving input information from a user identifying a location of a run-on sentence error in a displayed natural language sentence.

FIGS. 3A-3B depict a graphical user interface configured to allow a user to identify a location, within a displayed sentence, of a run-on sentence error.

FIG. 4 depicts a graphical user interface displaying remediation information about a portion of the displayed sentence.

FIG. 5 depicts a flowchart for receiving input information from a user identifying a correction of a run-on sentence error in a displayed natural language sentence and determining whether the correction is accurate.

FIGS. 6A-6B depict a graphical user interface configured to allow a user to input a correction for a run-on sentence error within a displayed sentence.

FIG. 7 depicts a graphical user interface displaying remediation information about an inaccurate correction, by a user, of a run-on sentence error.

FIG. 8 depicts a graphical user interface displaying a run-on sentence problem with multiple sentences.

FIG. 9 is a block diagram of a computer system on which embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

An automated grammar teaching system delivers highly personalized, differentiated instruction to users. The automated grammar teaching system provides lessons and adaptive practice to build each student's skills for the rules of natural language grammar with respect to run-on sentences. Run-on sentence problems, configured to address each students' continuous learning needs with respect to granular grammar skills relating to run-on sentences, are automatically presented to students by the automated grammar teaching system.

The system displays one or more sentences to a user, and allows the user to identify a location of a run-on sentence error within a sentence. The system further allows the user to correct the identified run-on sentence error. In an embodiment, if a user incorrectly identifies a particular portion of a sentence as a run-on sentence error, then the system displays remediation information to help the user understand the portion of the sentence that the user selected. In an embodiment, if a user provides an inaccurate correction to a run-on sentence error, the system displays remediation information to explain why the correction that the user specified is inaccurate. Further, the automated grammar teaching system records, as historical data, a user's actions within the system. The system uses this historical data to identify what sentences, with what kinds of run-on sentence errors, the system should provide to the user.

### Adaptive Grammar Instructions Architecture

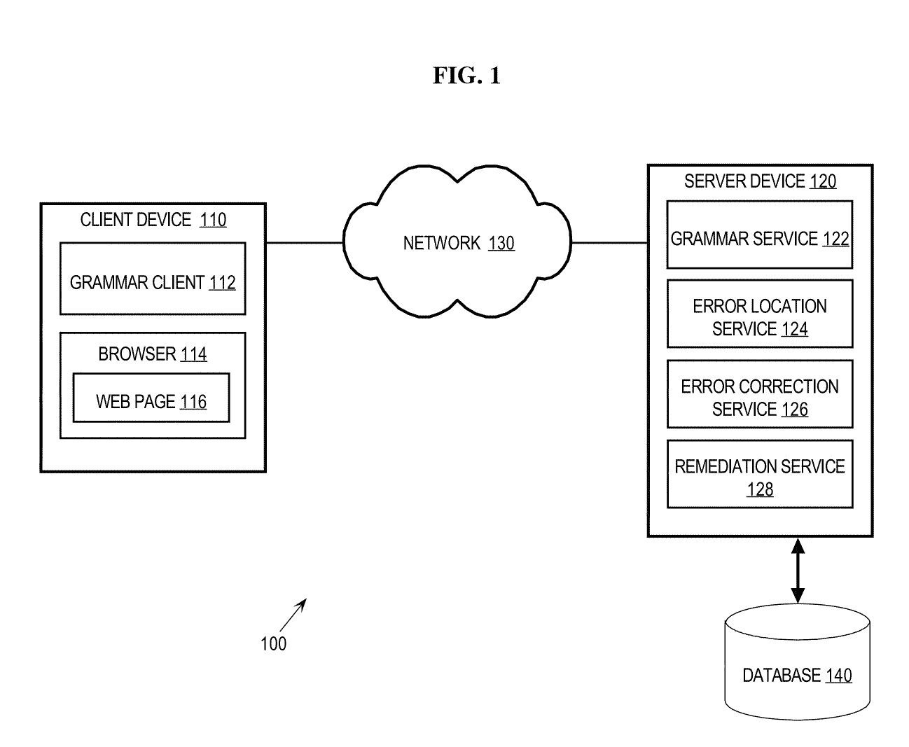

Techniques are described hereafter for adaptively instructing a user on grammar rules governing run-on sentences. FIG. 1 is a block diagram that depicts an example network arrangement 100 for an automated grammar teaching system that adaptively instructs a user regarding grammar rules governing run-on sentences, according to embodiments. Network arrangement 100 includes a client device 110 and a server device 120 communicatively coupled via a network 130. Server device 120 is also communicatively coupled to a database 140. Example network arrangement 100 may include other devices, including client devices, server devices, and display devices, according to embodiments. For example, one or more of the services attributed to server device 120 herein may run on other server devices that are communicatively coupled to network 130.

Client device 110 may be implemented by any type of computing device that is communicatively connected to network 130. Example implementations of client device 110 include, without limitation, workstations, personal computers, laptop computers, personal digital assistants (PDAs), tablet computers, cellular telephony devices such as smart phones, and any other type of computing device.

In network arrangement 100, client device 110 is configured with a grammar client 112 and a browser 114 that displays web page 116. Grammar client 112 may be implemented in any number of ways, including as a plug-in to browser 114, as an application running in connection with web page 116, as a stand-alone application running on client device 110, etc. Grammar client 112 may be implemented by one or more logical modules, and is described in further detail below. Browser 114 is configured to interpret and display web pages that are received over network 130 (e.g., web page 116), such as Hyper Text Markup Language (HTML) pages, and eXtensible Markup Language (XML) pages, etc. Client device 110 may be configured with other mechanisms, processes and functionalities, depending upon a particular implementation.

Further, client device 110 is communicatively coupled to a display device (not shown in FIG. 1), for displaying graphical user interfaces, such as graphical user interfaces of web page 116. Such a display device may be implemented by any type of device capable of displaying a graphical user interface. Example implementations of a display device include a monitor, a screen, a touch screen, a projector, a light display, a display of a tablet computer, a display of a telephony device, a television, etc.

Network 130 may be implemented with any type of medium and/or mechanism that facilitates the exchange of information between client device 110 and server device 120. Furthermore, network 130 may facilitate use of any type of communications protocol, and may be secured or unsecured, depending upon the requirements of a particular embodiment.

Server device 120 may be implemented by any type of computing device that is capable of communicating with client device 110 over network 130. In network arrangement 100, server device 120 is configured with a grammar service 122, an error location service 124, an error correction service 126, and a remediation service 128. One or more of services 122-128 may be part of a cloud computing service. Functionality attributed to one or more of services 122-128 may be performed by grammar client 112, according to embodiments. Services 122-128 may be implemented by one or more logical modules, and are described in further detail below. Server device 120 may be configured with other mechanisms, processes and functionalities, depending upon a particular implementation.

Server device 120 is communicatively coupled to database 140. Database 140 may reside in any type of storage, including volatile and non-volatile storage (e.g., random access memory (RAM), one or more hard or floppy disks, main memory, etc.), and may be implemented by multiple logical databases. The storage on which database 140 resides may be external or internal to server device 120.

Any of grammar client 112 and services 122-128 may receive and respond to Application Programming Interface (API) calls, Simple Object Access Protocol (SOAP) messages, requests via HyperText Transfer Protocol (HTTP), HyperText Transfer Protocol Secure (HTTPS), Simple Mail Transfer Protocol (SMTP), or any other kind of communication, e.g., from one of the other services 122-128 or grammar client 112. Further, any of grammar client 112 and services 122-128 may send one or more of the following over network 130 to one of the other entities: information via HTTP, HTTPS, SMTP, etc.; XML data; SOAP messages; API calls; and other communications according to embodiments.

In an embodiment, each of the processes described in connection with one or more of grammar client 112 and services 122-128 are performed automatically and may be implemented using one or more computer programs, other software elements, and/or digital logic in any of a general-purpose computer or a special-purpose computer, while performing data retrieval, transformation, and storage operations that involve interacting with and transforming the physical state of memory of the computer.

### Sentence Problems Stored at the Database

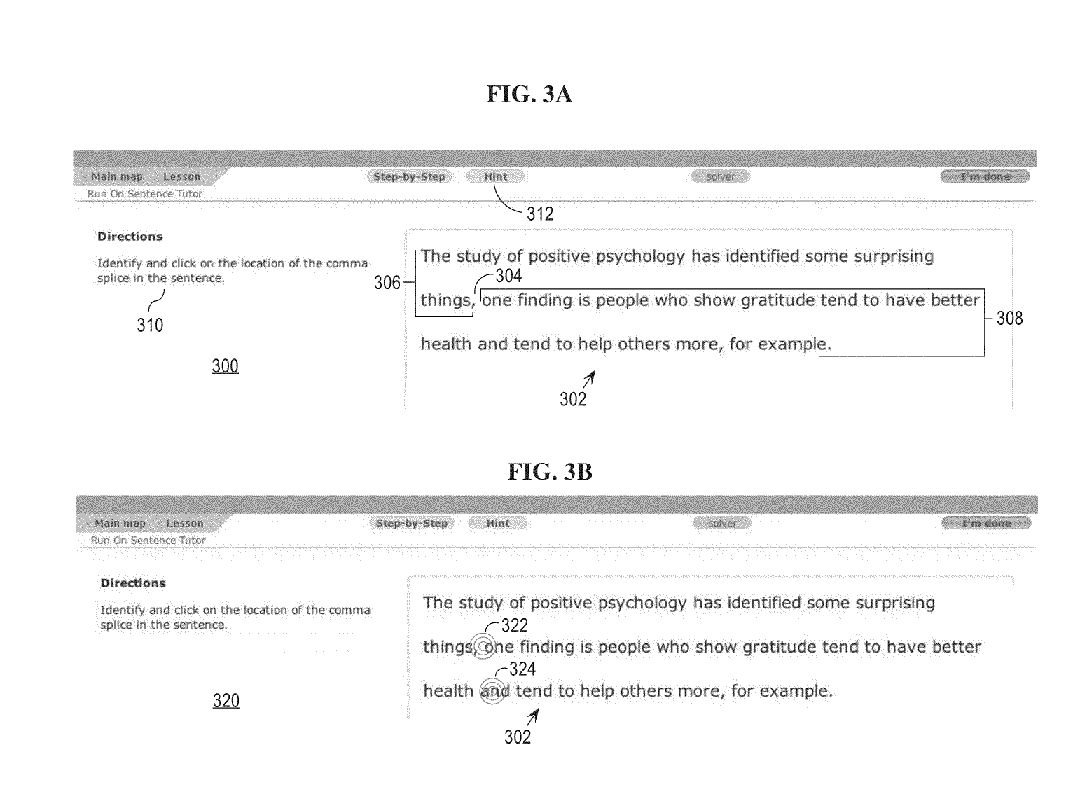

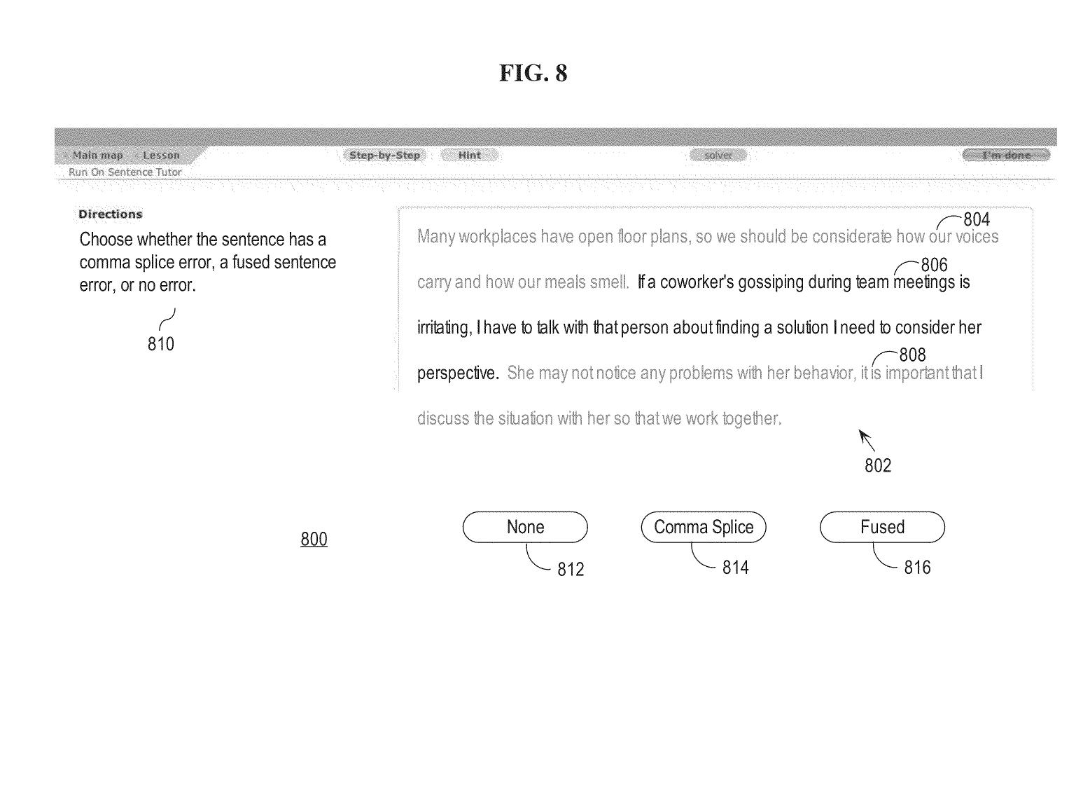

Database 140 stores a plurality of sets of problem data. In one embodiment, a set of problem data corresponds to a run-on sentence problem that may be displayed to a user, e.g., at graphical user interface (GUI) 300 of FIG. 3, at GUI 800 of FIG. 8, etc.

According to embodiments, a run-on sentence problem includes either (a) a single sentence (GUI 300), or (b) two or more sentences configured to be displayed together (GUI 800). A set of problem data also includes one or more of:
a type of run-on sentence;
markup of a run-on sentence (as described in further detail below);
information that may be presented as hints;
a location of a run-on sentence error within a sentence for the problem;
a type of a run-on sentence error in a run-on sentence for the problem;
appropriate corrections for a run-on sentence error in the problem;
alternate wordings for a sentence (also described in further detail below);
grammatical roles played by various phrases and clauses in a sentence for the problem;
remediation information regarding correct portions of a run-on sentence; etc.

To illustrate, database 140 may include, in connection with a particular set of problem data, metadata embedded into the following marked-up sentence: [_indepClause]$careers in healthcare administration continue to grow[/_indepClause][_fusedSentence/] [_indepClause]healthcare is a big business in the United States[/_indepClause] [_depClause]because it continues to create jobs and to $hire more people.[/_depClause]

The embedded metadata variables (“$careers”, and “$hire”) facilitate creating alternate wordings for the marked-up sentence. For example, database 140 also includes the following definitions of the embedded variables: ‘careers’:RandomChoiceGenerator(choices=[‘Careers’, ‘Job prospects’, ‘Positions’]), ‘hire’:RandomChoiceGenerator(choices=[‘hire’, ‘employ’, ‘recruit’]). According to an embodiment, the variables are resolved before the sentence is stored at database 140.

According to an embodiment, metadata for a sentence includes a tag that grammar service 122 may use for remediation information. Such metadata identifies one or more portions of a sentence that are correct. For example, a particular marked-up sentence includes the metadata tag [_introPhrase/] at a location of a correct comma, which indicates to grammar service 122 what kind of comma is at that location. As described in further detail below, remediation service 128 may use such metadata to identify particular remediation information to display to a user. For example, if a user identifies the introductory phrase comma in a particular displayed sentence as a grammar error, then remediation service 128 uses the tag that marks that comma to identify remediation text to display to the user.

According to an embodiment, run-on sentences in database 140 are authored to present one of the following three categories of run-on sentences: (a) a long sentence with a participle plus a short sentence; (b) a short sentence plus a long sentence with a compound verb; and (c) a short sentence plus a long sentence with a subordinate clause. Users tend to create run-on sentences of these three types, and presenting problems with sentences of these types gives users the opportunity to practice identifying and correcting errors in sentences that are likely to be difficult. (See Kagan, Dona M. (1980) “Run-On and Fragment Sentences: An Error Analysis.” Research in the Teaching of English. v14 n2: 127-38.) Also, if users tend to make errors that result in run-on sentences of the types listed above, then users are more likely to write according to the rules of grammar for run-on sentences if they master these types of run-on sentence errors. Other types of run-on sentences may be presented to users within embodiments.

### Graphical User Interface Displaying a Run-on Sentence

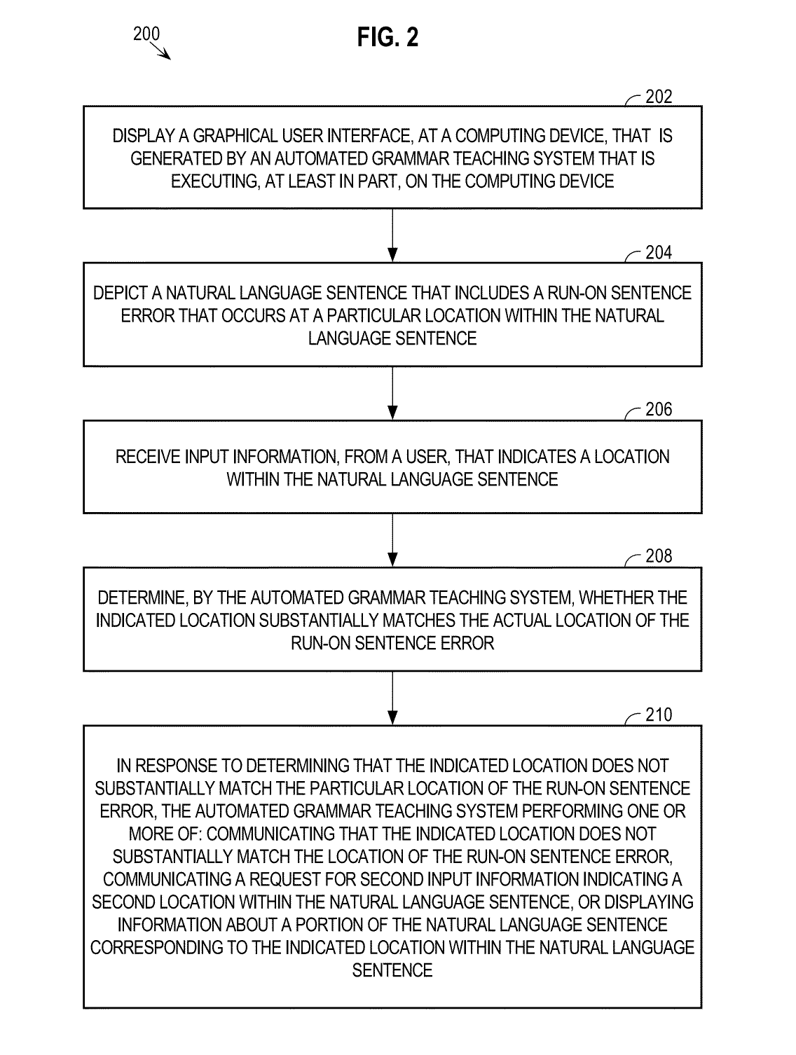

FIG. 2 depicts a flowchart 200 for receiving input information from a user identifying a location of a run-on sentence error in a displayed natural language sentence. At step 202 of flowchart 200, a graphical user interface is displayed at a computing device, which graphical user interface is generated by an automated grammar teaching system that is executing, at least in part, on the computing device. For example, in FIG. 1, web page 116 includes a graphical user interface such as GUI 300 of FIG. 3A, which is generated by grammar service 122 executing on server device 120 or by grammar client 112 executing on client device 110.

Grammar service 122 sends information for GUI 300, via network 130, to grammar client 112. Grammar client 112 makes GUI 300 available to browser 114 executing on client device 110, and browser 114 displays GUI 300, i.e., in web page 116. According to another embodiment, grammar client 112 causes GUI 300 to be displayed outside of a browser, e.g., as part of a stand-alone application.

At step 204 of flowchart 200, a natural language sentence is depicted, which includes a run-on sentence error that occurs at a particular location within the natural language sentence. To illustrate, GUI 300 depicts a natural language sentence 302 that, according to an embodiment, includes a run-on sentence error at location 304. A run-on sentence error is a grammatical error that causes a sentence to become a run-on sentence. According to another embodiment, sentence 302 may or may not contain a run-on sentence error, and grammar client 112 instructs users to determine whether the sentence includes a run-on sentence error as a preliminary matter.

A location of a run-on sentence error is a location, within a run-on sentence, at which a user may make an edit to cause the displayed sentence to no longer be a run-on sentence. A particular run-on sentence includes one or more locations of run-on sentence errors. According to embodiments, a particular sentence for a grammar problem includes no grammar error. For example, one or more sentences of multiple sentences displayed for a grammar problem include no grammar error. Grammar service 122 instructs the user to determine whether each of the displayed sentences includes a grammar error.

If a sentence includes multiple locations of run-on sentence errors, then it is possible that (a) the user need only make a correction at one of the locations in order to correct the run-on sentence; or (b) the user needs to make corrections at two or more of the locations in order to correct the run-on sentence. Embodiments described herein include run-on sentences that require correction at only one location. However, embodiments may include run-on sentences with multiple locations of run-on sentence errors.

According to an embodiment, a run-on sentence error may be categorized as one of the following two types: a fused sentence error, or a comma splice error. However, embodiments are not limited to these two types of run-on sentence errors. A fused sentence error consists of two natural language independent clauses joined without any joining punctuation to create an improper run-on sentence from the two component natural language independent clauses. A comma splice error consists of two logical natural language independent clauses joined by a comma to create an improper run-on sentence from the two component natural language independent clauses. For example, in sentence 302 of FIG. 3A, sentence component 306 is joined with sentence component 308 by a comma at location 304, resulting in a comma splice run-on sentence error at location 304. If there was no comma between sentence components 306 and 308, the resulting error would be a fused sentence error at location 304.

### Identifying a Location of a Run-on Sentence Error

At step 206, input information is received, from a user, that indicates a location within the natural language sentence. For example, grammar client 112 receives information, input by the user via GUI 300 that indicates a selected location within natural language sentence 302. A user may identify a selected location within the sentence in many ways, such as by clicking on a location within the depiction of natural language sentence 302 in GUI 300, or by moving a cursor to a location within the depiction of natural language sentence 302 in GUI 300 and selecting the location with a particular key stroke (such as ‘enter’, or ‘e’), etc.

FIG. 3A includes instructions 310 that instruct a user to identify the location of a run-on sentence error within sentence 302. This depiction of instructions is non-limiting, and the instructions may be presented in other manners, with other wording, or may be entirely absent, within embodiments.

At step 208, the automated grammar teaching system determines whether the indicated location substantially matches the actual location of the run-on sentence error. To illustrate, grammar client 112 sends the information indicating the selected location within sentence 302 to grammar service 122. Grammar service 122 employs error location service 124 to determine whether the user selected the actual location of the run-on sentence error.

According to an embodiment, error location service 124 determines that the selected location substantially matches the particular location of the run-on sentence error when the selected location is within a range of locations identified in the data for sentence 302 (e.g., stored at database 140), or derived from data for sentence 302. For example, data for sentence 302 identifies a set of one or more characters of sentence 302 at which the error occurs, i.e., the ‘,’ and the ‘ ’ at location 304. These characters may also be identified by their relative position within the ordered sequence of characters of natural language sentence 302, i.e., 0-based character numbers 70 (the ‘,’) and 71 (the ‘ ’). If there are multiple positions, within sentence 302, at which an adjustment could be made to fix the run-on sentence error, then the set of one or more characters at which the error occurs in sentence 302 includes characters from multiple disparate positions within the sentence.

According to another embodiment, error location service 124 determines that the selected location substantially matches the particular location of the run-on sentence error when the selected location is on an area of the GUI identified in data for sentence 302. In this embodiment, the area of the GUI identified for a particular grammar error comprises one or more of (a) whitespace and/or punctuation between words of the sentence; (b) characters of a particular word in the sentence; and (c) a range of words within the sentence. For example, data for sentence 302 identifies one or more word-based positions at which the error occurs, where words in a sentence are delineated by punctuation and/or white space. To illustrate, data for sentence 302 identifies, as the location of a grammar error, the position between 0-based word number 9 (“things”) and word number 10 (“one”), which may be denoted as position 9.5 within sentence 302.

According to an embodiment, grammar client 112 only allows a user to select space between words in a sentence, e.g., in connection with a grammar problem step requiring locating a grammar error and the location of the grammar error is necessarily between words of the sentence. According to an embodiment, grammar client 112 only allows a user to select one or more words in a sentence, e.g., in connection with a grammar problem step requiring locating a grammar error and the location of the grammar error necessarily comprises one or more words of the sentence.

Error location service 124 receives data indicating the location within sentence 302 that was selected by the user. To illustrate, FIG. 3B depicts locations 322 and 324 selected by a user within natural language sentence 302. If the input information from the user indicates that a user has selected location 322, then error location service 124 determines that the characters within sentence 302 that are incident to location 322 are ‘ ’ (character 71), and ‘o’ (character 72).

If at least one of the one or more characters within sentence 302 that are incident to the location selected by the user is in the set of one or more characters of sentence 302 at which the error occurs, then error location service 124 determines that the selected location substantially matches the particular location of the run-on sentence error. For example, location 322 substantially matches the location of the run-on sentence error in sentence 302 because location 322 is incident to character 71, which is in the set of one or more characters at which the error in sentence 302 occurs.

On the other hand, if no characters that are incident to the location selected by the user are in the set of one or more characters of sentence 302 at which the error occurs, then error location service 124 determines that the selected location does not substantially match the particular location of the run-on sentence error. For example, the input information indicates that a user has selected location 324, and error location service 124 determines that the characters within sentence 302 that are incident to location 324 are ‘a’ (character 140), and ‘n’ (character 141). Error location service 124 determines that location 324 does not substantially match the location of the run-on sentence error in sentence 302 because location 324 is not incident to any characters that are in the set of one or more characters at which the error in sentence 302 occurs.

Returning to flowchart 200 of FIG. 2, at step 210, the automated grammar teaching system performs one or more of the following actions in response to determining that the indicated location does not substantially match the particular location of the run-on sentence error:
communicating that the indicated location does not substantially match the location of the run-on sentence error;
communicating a request for second input information indicating a second location within the natural language sentence; or
displaying information about a portion of the natural language sentence corresponding to the indicated location within the natural language sentence.

For example, error location service 124 receives input information indicating that the user identified location 324 of FIG. 3B within sentence 302, and error location service 124 determines that location 324 does not substantially match the location of the run-on sentence error in sentence 302, as described above.

According to an embodiment, in response to the above determination of error location service 124, grammar client 112 communicates that the indicated location does not substantially match the location of the run-on sentence error. For example, grammar client 112 displays text that informs the user that the user has not correctly selected the location of the run-on sentence error within sentence 302. As another example, grammar client 112 displays a symbol or plays a sound to indicate to the user that the user has not correctly selected the location of the run-on sentence error within sentence 302. As yet another example, grammar client 112 simply does not move on to another problem or another portion of the present problem, which communicates to the user that the user has not correctly selected the location of the run-on sentence error within sentence 302. As yet another example, grammar client 112 displays an indication of the correct location (304) of the run-on sentence error within sentence 302.

According to an embodiment, grammar client 112 displays hint information in connection with communicating that the indicated location is not the location of the run-on sentence error. According to another embodiment, grammar client 112 displays hint information in response to detecting selection of hint button 312 (in GUI 300 of FIG. 3A). Displayed hint information may be from one of various levels of hint information from the data for sentence 302. Such levels may include (1) general instruction, (2) what concepts to think about for sentence 302, and (3) what the correct answer is and why.

According to another embodiment, in response to the above determination of error location service 124, grammar client 112 communicates a request for second input information indicating a second location within natural language sentence 302. For example, grammar client 112 displays text that requests that the user make another attempt to select the location of the run-on sentence error within sentence 302. As another example, grammar client 112 highlights instructions 310 within GUI 300 (e.g., with bolded text, font color, highlight color, a displayed symbol, a displayed border, etc.).

### Remediation Information in Response to Selection of an Incorrect Location for the Error

According to yet another embodiment, in response to the above determination of error location service 124, grammar client 112 displays “remediation information” about a portion of natural language sentence 302 that corresponds to the indicated location within the sentence. In this embodiment, grammar client 112 presents a user with targeted remediation information about mistakes made by the user in identifying run-on sentence errors. Information on why the identified portion of the sentence is not the location of a run-on sentence error educates the user on what is correct within the sentence, in the context of run-on sentence grammar rules, and therefore reinforces the user's knowledge of how to properly form sentences.

Remediation information includes information that explains to a user why a particular component of a sentence, at a particular location, is correct. According to an embodiment, database 140 stores remediation information, including text to be displayed, for each stored sentence. According to another embodiment, database 140 stores a collection of remediation information display text indexed by unique identifiers. In this embodiment, remediation information for a particular sentence includes unique identifiers of remediation information stored in the collection.

Remediation information is created based on one or more of (a) academic literature about what students know and the mistakes that students make, (b) what subject matter experts and/or cognitive scientists know about how students learn, and (c) analysis of historical data gathered by grammar service 122. For example, grammar service 122 records, in historical data for a user, the mistakes that the user makes in identifying and correcting run-on sentences, and what, if any, remediation information grammar client 112 was presented to the user in response to detecting the mistake. Trends in the historical data may be identified, e.g., by cognitive scientists, to determine what remediation information should be added to database 140.

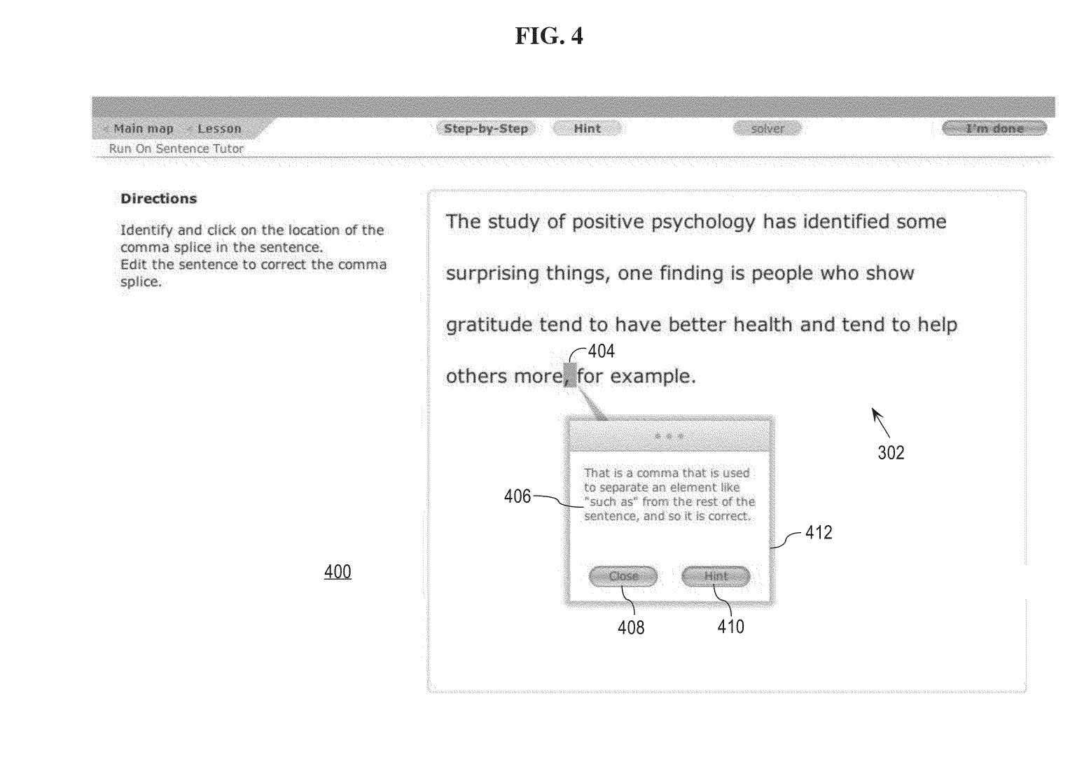

Grammar client 112 displays remediation information when the user identifies, as a run-on sentence error, a particular portion of the sentence that is not a run-on sentence error. To illustrate, FIG. 4 depicts a GUI 400 with sentence 302. Grammar client 112 receives input information indicating that the user has selected location 404 within sentence 302 as a location of a run-on sentence error, and grammar client 112 determines that location 404 does not substantially match the location of the run-on sentence error within sentence 302. In response to determining that location 404 does not substantially match the location of the run-on sentence error, grammar service 122 sends information indicating location 404 to remediation service 128. Remediation service 128 determines whether location 404 substantially matches any of the locations of remediation information within sentence 302. A location of remediation information is a location, within the related natural language sentence, to which the remediation information refers.

If location 404 substantially matches a location of remediation information within sentence 302, then grammar service 122 causes grammar client 112 to display remediation information 406 to the user. Remediation information 406 is in visual association with the portion of sentence 302 at location 404 because GUI component 412 visually associates remediation information 406 with the depiction of that portion of the sentence in GUI 400. Remediation information 406 describes why the indicated component of sentence 302, at location 404, is not the location of a run-on sentence error. In the case of the comma at location 404, remediation information 406 indicates that the comma is actually correct because that comma is acting to separate a connective transition phrase from the rest of sentence 302.

A user may hide remediation information 406 and continue with the problem by activating close button 408. The user may request a hint, as described above, by activating hint button 410.

### Correcting a Run-on Sentence Error

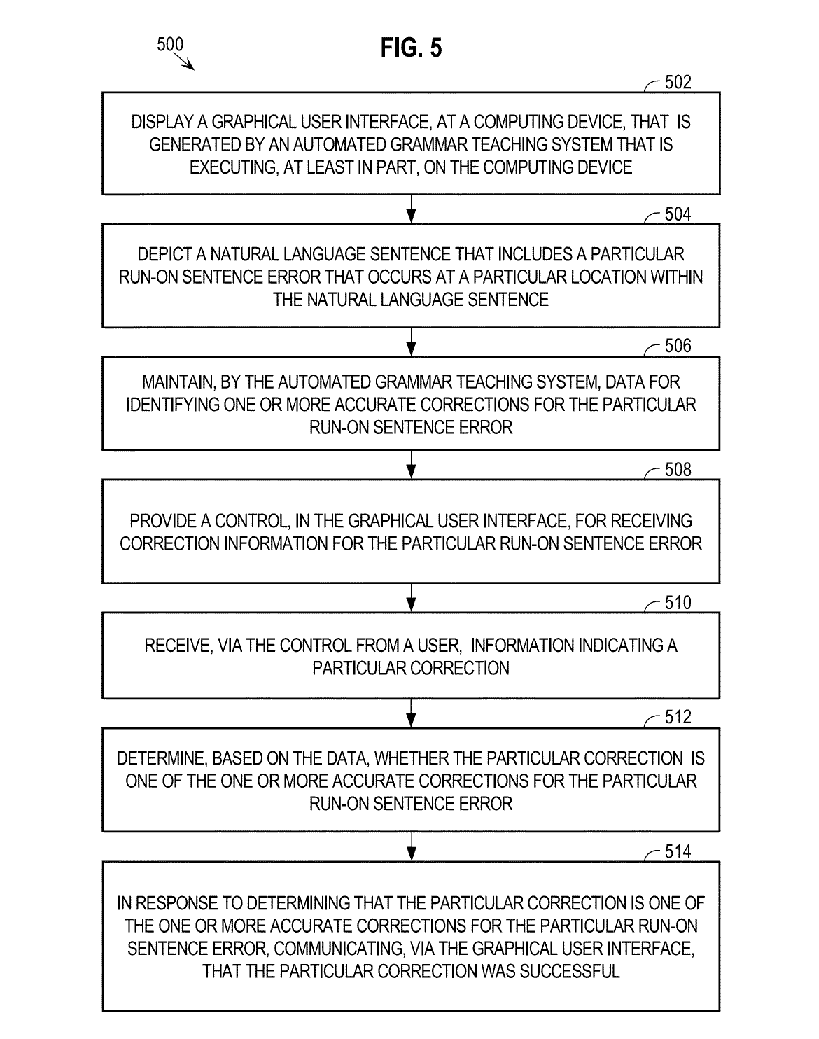

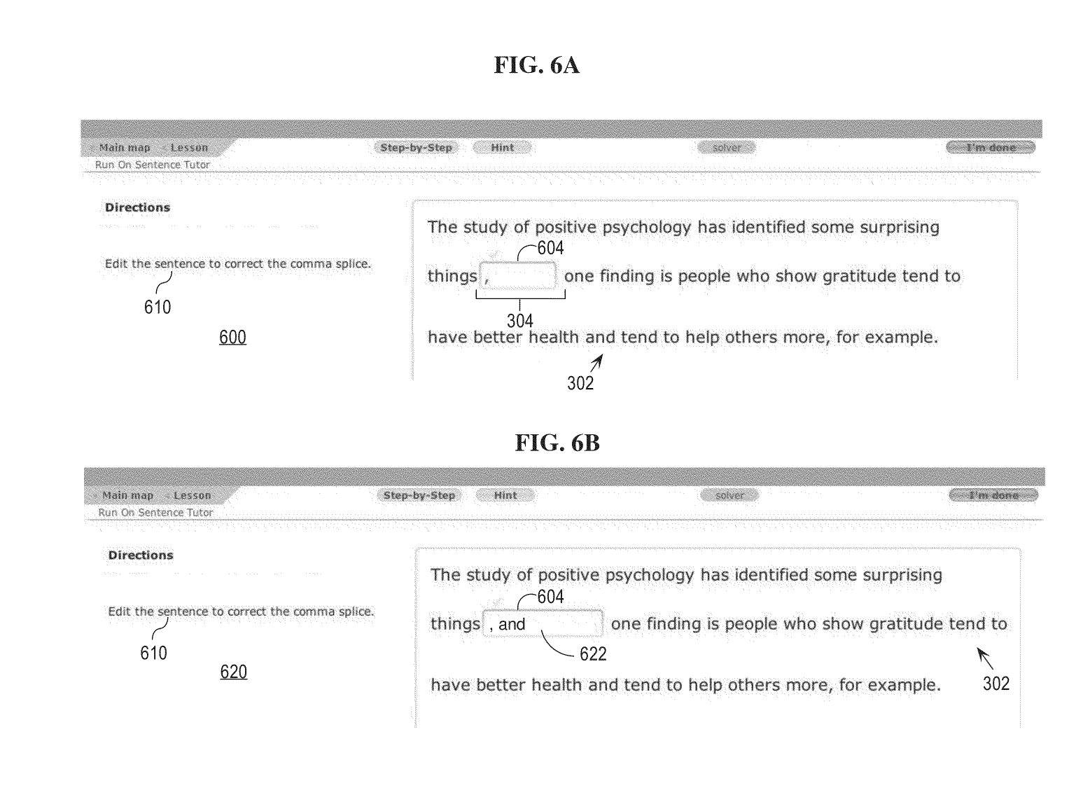

FIG. 5 depicts a flowchart 500 for receiving input information from a user identifying a correction of a run-on sentence error in a displayed natural language sentence and determining whether the correction is accurate. At step 502 of flowchart 500, a graphical user interface is displayed at a computing device, which graphical user interface is generated by an automated grammar teaching system that is executing, at least in part, on the computing device. For example, web page 116 includes a GUI such as GUI 600 of FIG. 6A, which is generated by grammar service 122 executing on server device 120 or by grammar client 112 executing on client device 110.

At step 504 of flowchart 500, a natural language sentence is depicted, which includes a run-on sentence error that occurs at a particular location within the natural language sentence. For example, GUI 600 depicts natural language sentence 302 that includes a run-on sentence error at location 304.

At step 506, the automated grammar teaching system maintains data for identifying one or more accurate corrections for the particular run-on sentence error. For example, database 140 includes a set of one or more accurate correction options for the particular run-on sentence error. To illustrate in the context of sentence 302, database 140 has information indicating that the following correction options are accurate for the run-on sentence error in sentence 302:
“.”
“;”
“, [CoordinatingConjunction]”
“; [ConnectiveTransitionWord],”
“. [ConnectiveTransitionWord],”
   [CoordinatingConjunction] represents any one of a part-of-speech list for coordinating conjunctions to correct the error in sentence 302, including “for”, “nor”, “but”, “or”, “and”, etc. [ConnectiveTransitionWord] represents any one of a part-of-speech list for connective transition words to correct the error in sentence 302, including “Specifically”, “To illustrate”, etc. According to an embodiment, each sentence in database 140 is associated with applicable part-of-speech lists that may be used in the sentence, which part-of-speech lists may include subsets of all possible words and/or phrases that are included in the particular part-of-speech. Sentence-specific part-of-speech lists are useful because, e.g., not all coordinating conjunctions or connective transition words may be used to correct the error in sentence 302.

At step 508, a control is provided, in the graphical user interface, for receiving correction information for the particular run-on sentence error. For example, grammar client 112 causes text box control 604 of FIG. 6A to be available to the user at location 304 (in line with the text of sentence 302), which is the location of the run-on sentence error in sentence 302. According to the example of GUI 600, text box control 604 includes an editable comma, since the comma is part of the comma splice error in sentence 302. In embodiments, any part of (i.e., any subset of characters), all of, or none of the string of the displayed sentence may be available for editing within text box control 604. According to one embodiment, when the error is a comma splice-type error, the control includes the comma, which causes the comma splice, for editing. In this embodiment, when the error is a fused-sentence-type error, the control includes none of the displayed sentence for editing.

At step 510, information indicating a particular correction is received via the control from a user. For example, FIG. 6B depicts a GUI 620 in which a user has input a correction string 622 into control 604. Grammar client 112 receives information indicating correction string 622 via control 604 and sends the information to grammar service 122.

At step 512, it is determined, based on the data, whether the particular correction is one of the one or more accurate corrections for the particular run-on sentence error. For example, grammar service 122 employs error correction service 126 to determine whether correction string 622 is one of the accurate corrections for sentence 302. Error correction service 126 compares correction string 622 to the set of correction options, stored at database 140, that are accurate for the run-on sentence error in sentence 302. To determine whether correction string 622 substantially matches one of the set of accurate correction options for sentence 302, error correction service 126 uses regular expressions. Since there are a variety of ways that a user can input right and wrong answers, flexibility can be built into error correction service 126 using regular expressions.

Error correction service 126 compares correction string 622 to each of the accurate correction options stored at database 140 in turn. To illustrate determining whether correction string 622 substantially matches the accurate correction option “, [CoordinatingConjunction]”, error correction service 126 first uses regular expressions to determine whether there is a comma followed by a word in string 622. In the case of string 622, there is a comma followed by the word “and”. Error correction service 126 then uses regular expressions to compare the word in string 622 to the list of coordinating conjunctions for the run-on sentence error in sentence 302. “And” is one of the coordinating conjunctions on the list, so error correction service 126 determines that “, and” in string 622 is an accurate correction of the run-on sentence error in sentence 302.

According to embodiments, error correction service 126 automatically corrects the spelling of words that are input as corrections to run-on sentences. In one embodiment, common misspellings of words in a part-of-speech list for a particular run-on sentence error are also included in the list. For example, both “and” and “adn” (a common misspelling of “and”) are included in the list of coordinating conjunctions for sentence 302. Thus, error correction service 126 would recognize “adn” as a coordinating conjunction appropriate to correct sentence 302.

In another embodiment, database 140 includes a list of common misspellings of words, along with the correct spelling of the word. Before checking to see if a particular word is included in a part-of-speech list for a particular error, error correction service 126 determines whether an alternative spelling of the word is included in the list of common misspellings of words. If an alternative spelling is found, error correction service 126 checks the alternative spelling against the appropriate part-of-speech list. Other ways to spell-check a word may be used within embodiments, including using a third party spell-checker application.

According to an embodiment, error correction service 126 normalizes white space in correction string 622 by transforming each instance of contiguous white space within string 622 into a single space, or some other standard amount and kind of white space that is expected by the system (and that is used in the list of accurate correction options for sentence 302). According to another embodiment, error correction service 126 uses the white space in an input correction string, if there is any, to parse the string into tokens. To illustrate, error correction service 126 parses string 622 into two ordered tokens: the token “,” followed by the token “and”. Thus, the effect of differences in white space between otherwise identical answers is nullified.

At step 514, in response to determining that the particular correction is one of the one or more accurate corrections for the particular run-on sentence error, it is communicated, via the graphical user interface, that the particular correction was successful. For example, grammar client 112 displays text that informs the user that the user has accurately corrected the run-on sentence error in sentence 302. As another example, grammar client 112 displays a symbol or plays a sound to indicate to the user that the user has accurately corrected the run-on sentence error within sentence 302. As yet another example, grammar client 112 simply moves on to another problem or another portion of the present problem, which communicates to the user that the user has accurately selected the location of the run-on sentence error within sentence 302.

Requiring a student to remember and formulate a correction to a run-on sentence error is different, and more difficult, than merely requiring a student to recognize an accurate correction to a run-on sentence error (i.e., from a set of provided correction choices, such as with a multiple choice problem). Furthermore, the embodiments described above in connection with flowchart 500 more accurately test a user's working knowledge of the rules of grammar governing run-on sentences than does a multiple choice problem because, when writing a sentence, a user must remember and formulate sentences in such a way to avoid run-on sentence errors, generally without visual prompts.

### Remediation Information in Response to Inaccurate User Correction of the Error

According to embodiments, the automated grammar teaching system of FIG. 1 provides a user with remediation feedback on specific types of inaccurate corrections of run-on sentence errors submitted to the system by users. For example, remediation service 128 is configured with regular expressions that remediation service 128 uses to identify whether a particular inaccurate correction string, input by a user, is of a type of correction for which remediation service 128 has remediation information.

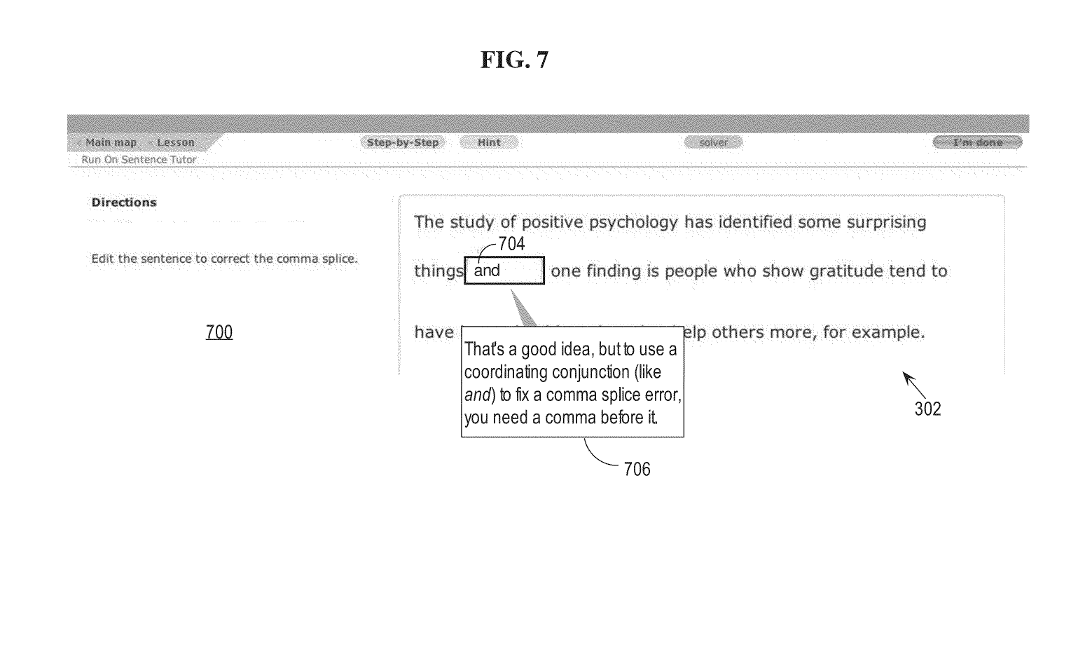

For example, FIG. 7 depicts a GUI 700 in which a user has input, as a correction of sentence 302, correction string 704. Error correction service 126 determines that string 704 is not an accurate correction of sentence 302. In response to determining that string 704 is not an accurate correction of sentence 302, grammar service 122 causes remediation service 128 to determine whether string 704 represents a type of correction for which there is remediation information. Remediation service 128 determines, using regular expressions, that string 704 represents a coordinating conjunction used without a preceding comma. In response, grammar client 112 causes GUI 700 to display remediation information 706 visually associated with string 704, which remediation information informs the user as to why correction string 704 is insufficient to remedy the particular run-on sentence error in sentence 302.

According to this embodiment, database 140 contains remediation information for one or more of the following:
Identifying one of several classes of correct comma usage as the location of the error:
Correcting the sentence with a coordinating conjunction with incorrect punctuation;
Correcting the sentence with a conjunctive adverb with incorrect punctuation;
Correcting the sentence with a coordinating conjunction or conjunctive adverb that is correct for some sentences but not the particular sentence at hand;
Correcting the sentence with punctuation that is never appropriate; and
Correcting the sentence with punctuation that is appropriate for some sentences but not for the particular sentence at hand.

### Sequence of the Run-on Sentence Problem

According to an embodiment, grammar client 112 presents a control for receiving correction information for a run-on sentence only in response to the user correctly identifying the location of a run-on sentence error within the sentence. According to another embodiment, a control for receiving correction information for a run-on sentence is presented in response to either: the user identifying the correct location of the error within the sentence; or grammar client 112 displaying information showing, to the user, the correct location of the error.

For example, grammar client 112 displays information showing, to the user, the correct location of a run-on sentence error once the user has selected a threshold number of locations, within a displayed sentence, that do not substantially match the correct location of a run-on sentence error within the sentence. The user may be given a control to dismiss the information showing the correct location of the error; in such an embodiment, the control for receiving correction information is displayed in response to grammar client 112 detecting activation of the control to dismiss the information showing the correct location of the error.

According to another embodiment, grammar client 112 displays a control for receiving correction information for a run-on sentence without requiring that the user correctly identify the location of a run-on sentence error within the sentence. For example, grammar client 112 presents a user with a first sentence in a GUI, such as GUI 300, that is configured to receive information indicating a location within the sentence, and grammar client 112 presents the user with a second sentence in a GUI, such as GUI 600, that is configured with a control to receive correction information for a run-on sentence error.

### Tracking and Using Historical Data

Grammar service 122 identifies which run-on sentence problem to display to a user based, at least in part, on user information stored at database 140. According to an embodiment, the automated grammar teaching system of FIG. 1 is configured to maintain historical data for a user, e.g., in a user profile for the user stored at database 140. Such historical data includes one or more of: previous problems that have been presented to the user, types of previous problems that have been presented to the user, correct and incorrect answers given by the user, timing of viewing and answering presented questions, etc.

Based, at least in part, on the historical data, grammar service 122 identifies run-on sentence problems, to present to the user, that target concepts within the grammar rules governing run-on sentences with which the user has had trouble. The way that grammar service 122 interprets the data is configurable by an administrator of the system. For example, an administrator sets a rule in grammar service 122 that states that a user needs additional practice for a particular run-on sentence concept when the user misses over 50% of problems that feature the particular run-on sentence concept during the past seven days. At a certain point in time, the historical data for a particular user indicates that the user has made mistakes on a particular kind of run-on sentence 80% of the times that sentences of this type have been presented to the user in the past week. Based on this historical data and the administrator-set rule, grammar service 122 presents run-on sentences of that type to the user at a higher rate than other types of sentences until grammar service 122 identifies that the rate of making mistakes on this type of problem is no longer over 50%.

According to embodiments:
1. A set of grammar skills that users are expected to master are identified, e.g., by cognitive scientists and/or subject matter experts;
2. Steps in individual problems are associated with particular grammar skills, e.g., by cognitive scientists and/or subject matter experts;
3. As the user progresses, the user's probability of mastery for each individual grammar skill is automatically calculated (according to Bayesian Knowledge Tracing), e.g., by grammar service 122; and
4. Problems that have associated grammar skills that the user has not mastered are automatically presented, until the user has mastered all of the grammar skills associated with available grammar problems, e.g., by grammar service 122.

In connection with run-on sentences, grammar service 122 tracks the following grammar skills:
Identify an error in a compound-complex sentence;
Identify an error in a compound sentence that has a participle (-ing word);
Identify an error in a compound sentence that has a compound verb;
Identify a sentence with no errors;
Locate the error in a compound-complex sentence;
Locate the error in a compound sentence that has a participle (-ing word);
Locate the error in a compound sentence that has a compound verb;
Correct a comma splice error with punctuation and/or connecting words; and
Correct a fused sentence error with punctuation and/or connecting words.

### Corrections of Multiple-Sentence Paragraphs

According to an embodiment, at least some of the run-on sentence problems in database 140 include data for multiple sentences that are configured to be presented all together to a user, i.e., in paragraph form. For example, FIG. 8 depicts a GUI 800 in which a paragraph 802 is displayed, having sentences 804, 806, and 808. In the embodiment of GUI 800 of FIG. 8, grammar client 112 causes each sentence to be highlighted in turn, and allows a user to determine whether the highlighted sentence includes a run-on sentence error. In GUI 800, sentence 806 is highlighted and instructions 810 instruct the user to choose whether or not the sentence has an error, and the name of the error if one is present, i.e., via button controls 812, 814, and 816.

Grammar client 112 also allows the user to determine locations of any run-on sentence errors, and to submit corrections of the run-on sentence errors. In an embodiment, a user must determine whether a particular sentence (e.g., sentence 804) has a run-on sentence error, then locate the error, and then accurately correct the error in sequence (as described above) prior to moving on to another displayed sentence (e.g., sentence 806). According to an embodiment, a particular displayed paragraph will include at least one sentence that has no run-on sentence error, at least one sentence with a comma splice-type run-on sentence error, and at least one sentence with a fused run-on sentence error. According to another embodiment, a particular displayed paragraph will include at least one sentence with at least one run-on sentence error.

If the user correctly determines that there is not a run-on sentence error, then grammar client 112 highlights a different sentence of the plurality of displayed sentences and continues as with the first highlighted sentence. However, if the user correctly determines that there is a run-on sentence error, grammar client 112 provides the user the opportunity to identify a location within the highlighted sentence in a manner similar to identifying a location of a run-on sentence error for a single sentence, as described in detail above. Further, grammar client 112 provides the user with a control that receives information comprising a correction of the run-on sentence error and grammar client 112 causes the submitted correction to be checked for accuracy, as also described above in connection with a single sentence problem.

Providing the user multiple sentences in the form of a paragraph gives the user an even more realistic simulation of applying run-on sentence grammar rules in the real-world setting of drafting and editing a paragraph. Users must be able to apply run-on sentence grammar rules in the context of a multiple-sentence paragraph, as displayed in GUI 800. The flow of the sentences and the additional information presented to the user in the paragraph can make it more challenging for certain users to apply proper run-on sentence grammar rules. Thus, completing paragraph-style problems as in GUI 800 can help better prepare such users to correctly apply run-on sentence grammar rules in prose-style writing assignments and other writing opportunities.

### Intelligent Tutoring System for Automatically Teaching Grammar

According to an embodiment, grammar service 122 and/or grammar client 112 is implemented as part of an intelligent tutoring system, such as the cognitive tutor described in Kenneth R. Koedinger, John R. Anderson, William H. Hadley, & Mary A. Mark Intelligent tutoring goes to school in the big city §2.2 (7th World Conference on Artificial Intelligence in Education 1995), which paper is incorporated herein by reference.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

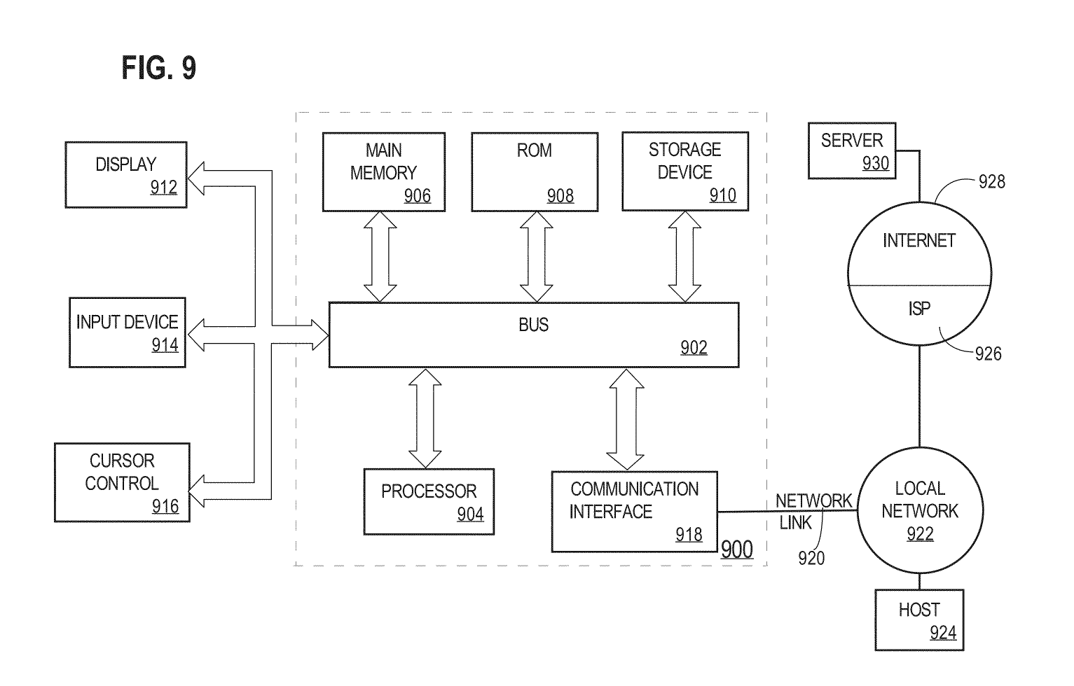

For example, FIG. 9 is a block diagram that illustrates a computer system 900 upon which an embodiment of the invention may be implemented. Computer system 900 includes a bus 902 or other communication mechanism for communicating information, and a hardware processor 904 coupled with bus 902 for processing information. Hardware processor 904 may be, for example, a general purpose microprocessor.

Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Such instructions, when stored in non-transitory storage media accessible to processor 904, render computer system 900 into a special-purpose machine that is customized to perform the operations specified in the instructions.

Computer system 900 further includes a read only memory (ROM) 908 or other static storage device coupled to bus 902 for storing static information and instructions for processor 904. A storage device 910, such as a magnetic disk, optical disk, or solid-state drive is provided and coupled to bus 902 for storing information and instructions.

Computer system 900 may be coupled via bus 902 to a display 912, such as a cathode ray tube (CRT), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

Computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor 904 executing one or more sequences of one or more instructions contained in main memory 906. Such instructions may be read into main memory 906 from another storage medium, such as storage device 910. Execution of the sequences of instructions contained in main memory 906 causes processor 904 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 910. Volatile media includes dynamic memory, such as main memory 906. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more instructions to processor 904 for execution. For example, the instructions may initially be carried on a magnetic disk or solid-state drive of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card, cable modem, satellite modem, or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are example forms of transmission media.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918.

The received code may be executed by processor 904 as it is received, and/or stored in storage device 910, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-executed method comprising:
displaying a graphical user interface, at a computing device, that depicts a natural language sentence;
wherein the graphical user interface is generated by an automated grammar teaching system that is executing, at least in part, on the computing device;
wherein the natural language sentence includes a run-on sentence error that occurs at a particular location within the natural language sentence;
receiving input information, from a user, that indicates a location within the natural language sentence;
determining, by the automated grammar teaching system, whether the indicated location substantially matches the particular location of the run-on sentence error;
in response to determining that the indicated location does not substantially match the particular location of the run-on sentence error, the automated grammar teaching system performing one or more of:
communicating that the indicated location does not substantially match the location of the run-on sentence error,
communicating a request for second input information indicating a second location within the natural language sentence, or
displaying information about a portion of the natural language sentence corresponding to the indicated location within the natural language sentence.

2. The method of claim 1, wherein:
the particular location of the run-on sentence error comprises a range of locations within the natural language sentence; and
determining whether the indicated location substantially matches the particular location of the run-on sentence error comprises determining whether the indicated location is within the range of locations for the run-on sentence error.

3. The method of claim 2, wherein:
the range of locations comprises references to a set of two or more natural language characters within the natural language sentence; and
determining whether the indicated location is within the range of locations for the run-on sentence error comprises determining whether one or more characters, in the natural language sentence, that are incident to the indicated location are in the set of two or more natural language characters within the natural language sentence.

4. The method of claim 1, comprising the automated grammar teaching system communicating that the indicated location does not substantially match the location of the run-on sentence error in response to determining that the indicated location does not substantially match the particular location of the run-on sentence error.

5. The method of claim 1, comprising the automated grammar teaching system communicating a request for second input information indicating a second location within the natural language sentence in response to determining that the indicated location does not substantially match the particular location of the run-on sentence error.

6. The method of claim 1, comprising the automated grammar teaching system displaying information about a portion of the natural language sentence corresponding to the indicated location within the natural language sentence in response to determining that the indicated location does not substantially match the particular location of the run-on sentence error.

7. The method of claim 1, wherein displaying information about a portion of the natural language sentence corresponding to the indicated location within the natural language sentence further comprises:
determining whether the indicated location substantially matches a location for remediation information for the natural language sentence; and
in response to determining that the indicated location substantially matches the location for remediation information for the natural language sentence, displaying the remediation information in visual association with the portion of the natural language sentence.

8. The method of claim 1, further comprising:
after determining that the indicated location does not substantially match the particular location of the run-on sentence error, receiving second input information indicating a second location within the natural language sentence;
determining, by the automated grammar teaching system, whether the second location substantially matches the particular location of the run-on sentence error; and
in response to determining that the indicated location substantially matches the particular location of the run-on sentence error, providing a control, in the graphical user interface, for receiving correction information for the run-on sentence error.

9. The method of claim 1, further comprising:
recording, in a set of historical data for the user, information about the depicted natural language sentence and the indicated location;
based, at least in part, on the set of historical data for the user, selecting a second natural language sentence; and
displaying a second graphical user interface, at the computing device, that depicts the second natural language sentence.

10. A computer-executed method comprising:
displaying a graphical user interface, at a computing device, that depicts a particular natural language sentence;
wherein the graphical user interface is generated by an automated grammar teaching system that is executing, at least in part, on the computing device;
wherein the particular natural language sentence includes a particular run-on sentence error that occurs at a particular location within the particular natural language sentence;
maintaining, by the automated grammar teaching system, data for identifying one or more accurate corrections for the particular run-on sentence error;
providing a control, in the graphical user interface, for receiving correction information for the particular run-on sentence error;
receiving, via the control from a user, information indicating a particular correction;
determining, based on the data, whether the particular correction is one of the one or more accurate corrections for the particular run-on sentence error;
in response to determining that the particular correction is one of the one or more accurate corrections for the particular run-on sentence error, communicating, via the graphical user interface, that the particular correction was successful.

11. The method of claim 10, wherein the control for receiving correction information for the particular run-on sentence error initially includes at least a portion of a string representing the particular natural language sentence, which portion of the string is editable by the user via the control.

12. The method of claim 10, wherein:
the graphical user interface displays a plurality of natural language sentences, which includes the particular natural language sentence; and
the method further comprises, prior to providing the control, in the graphical user interface, for receiving correction information:
highlighting the particular natural language sentence, among the plurality of natural language sentences,
receiving input information, from the user, indicating that the particular natural language sentence includes a run-on sentence error, and
at least partly in response to receiving the input information indicating that the particular natural language sentence includes a run-on sentence error, providing the control, in the graphical user interface, for receiving correction information.

13. The method of claim 10, wherein:
the particular correction comprises one or more natural language characters; and
determining, based on the data, whether the particular correction is one of the one or more accurate corrections for the particular run-on sentence error comprises using regular expressions to perform one or more of:
normalizing white space in the particular correction,
identifying an alternative spelling of a word in the particular correction,
identifying punctuation within the particular correction,
identifying a location of punctuation relative to one or more words in the particular correction, and
determining whether a particular word in the particular correction is in a set of words identified in a particular accurate correction of the one or more accurate corrections for the particular run-on sentence error.

14. The method of claim 10, wherein the control for receiving correction information for the particular run-on sentence error is depicted, in the graphical user interface, proximate to a location, in the particular natural language sentence, of the particular run-on sentence error and in line with displayed text of the particular natural language sentence.

15. The method of claim 10, further comprising:
recording, in a set of historical data for the user, information about the particular natural language sentence and the particular correction;
based, at least in part, on at least a portion of the set of historical data for the user, selecting a second natural language sentence; and
displaying a second graphical user interface, at the computing device, that depicts the second natural language sentence.

16. The method of claim 10, further comprising:
displaying a second graphical user interface, at the computing device, that depicts a second natural language sentence;
wherein the second natural language sentence includes a second run-on sentence error that occurs at a certain location within the second natural language sentence;
maintaining, by the automated grammar teaching system, second data for identifying one or more accurate corrections for the second run-on sentence error;
providing a second control, in the second graphical user interface, for receiving second correction information for the second run-on sentence error;
receiving, via the second control from a user, information indicating a second correction;
determining, based on the second data, whether the second correction is one of the one or more accurate corrections for the second run-on sentence error;
in response to determining that the second correction is not one of the one or more accurate corrections for the second run-on sentence error, displaying a message communicating information about why the second correction is not accurate.

17. A non-transitory computer readable medium storing instructions which, when executed by one or more processors, cause performance of the steps of:
displaying a graphical user interface, at a computing device, that depicts a natural language sentence;
wherein the graphical user interface is generated by an automated grammar teaching system that is executing, at least in part, on the computing device;
wherein the natural language sentence includes a run-on sentence error that occurs at a particular location within the natural language sentence;
receiving input information, from a user, that indicates a location within the natural language sentence;
determining, by the automated grammar teaching system, whether the indicated location substantially matches the particular location of the run-on sentence error;
in response to determining that the indicated location does not substantially match the particular location of the run-on sentence error, the automated grammar teaching system performing one or more of:
communicating that the indicated location does not substantially match the location of the run-on sentence error,
communicating a request for second input information indicating a second location within the natural language sentence, or
displaying information about a portion of the natural language sentence corresponding to the indicated location within the natural language sentence.

18. A non-transitory computer readable medium storing instructions which, when executed by one or more processors, cause performance of the steps of:
displaying a graphical user interface, at a computing device, that depicts a particular natural language sentence;
wherein the graphical user interface is generated by an automated grammar teaching system that is executing, at least in part, on the computing device;
wherein the particular natural language sentence includes a particular run-on sentence error that occurs at a particular location within the particular natural language sentence;
maintaining, by the automated grammar teaching system, data for identifying one or more accurate corrections for the particular run-on sentence error;
providing a control, in the graphical user interface, for receiving correction information for the particular run-on sentence error;
receiving, via the control from a user, information indicating a particular correction;
determining, based on the data, whether the particular correction is one of the one or more accurate corrections for the particular run-on sentence error;
in response to determining that the particular correction is one of the one or more accurate corrections for the particular run-on sentence error, communicating, via the graphical user interface, that the particular correction was successful.
